(19) United States
(12) Patent Application Publication
(10) Pub. No.: US 2006/0198350 A1
(43) Pub. Date: Sep. 7, 2006

(54) Method for transmitting messages in mobile communications system and mobile communications terminal

(75) Inventor: Jong-Hwan Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/367,321

(22) Filed: Mar. 6, 2006

(30) Foreign Application Priority Data
Mar. 7, 2005 (KR) 10-2005-0018822

(51) Int. Cl. H04L 12/28; H04L 1/00; H04L 12/56; H04Q 7/24; H04L 12/26

(52) U.S. Cl. 370/338; 370/229; 370/389

(57) ABSTRACT

A mobile terminal, system and method for transmitting and/or receiving a message are discussed. According to an embodiment, the mobile terminal includes a transmitting/receiving unit to perform a signal transmission; an input unit to receive a message and transmission information; a storage unit to store message data; and a controller to determine a message transmission mode of the message based on the transmission information, and to perform one of a general transmission process, a priority transmission process and a multiple-selection transmission process for the message based on the determined message transmission mode.

The present application claims the priority benefit of Korean Patent Application No. 10-2005-0018822 filed on Mar. 7, 2005 in Republic of Korea, the entire contents of which are hereby fully incorporated by reference.

### BACKGROUND OF THE INVENTION

1. Field of the Invention

The present invention relates to a mobile communications system, and particularly, to a mobile communications terminal and method for transmitting a message in a mobile communications system so as to be capable of transmitting a message to one or more receptions types related to a reception type known to a user. The present invention also relates to a mobile terminal, method and system for receiving such a message.

2. Description of the Background Art

Because of recent developments in a mobile communications system and interworking between the mobile communications system and wired/wireless Internet, a user can transmit a message to various reception types. For instance, using a short message service (SMS) message transmission method of a mobile terminal, the user can send a mail to an e-mail address of another party or leave a message on a web page or a bulletin board of a personal Internet homepage of another party or of another web site. Also, a picture captured by a mobile terminal provided with a camera may be uploaded to a web page such as a personal album on the web by a multimedia message service (MMS) transmission method.

FIG. 1 is a flow chart which illustrates a message transmission process in accordance with a related art method for transmitting a message.

As shown, first, in order to transmit a message to an Internet site, the user sets up a mobile terminal for accessing the Internet (S110). When the mobile terminal accesses the wireless Internet network, the user inputs a URL (Uniform Resource Locator) address to access (S120) and sets up the mobile terminal for wirelessly accessing the inputted web page address (S130). After accessing the web page, the user moves to a bulletin board or a guest board of the corresponding web page, and writes and stores a text thereon using the mobile terminal (S140). After the text is written and stored, the mobile terminal transmits the written text as a message to a server providing a corresponding web page service (S150). Thereafter, when the writing and transmitting of the message (storing the message on the web page) is completed, the user then cancels the connection between the mobile terminal and the web page, thereby terminating the message transmission (S160).

The above-discussed related art method for transmitting a message using the mobile terminal, however, has problems in that the cost of the message transmission is relatively high since the Internet connection needs to be maintained until the message writing is finished.

Furthermore, in the related art method for transmitting the message, a URL (Uniform Resource Locator) address of a web page that the user desires to access or an e-mail address of the destination party needs to be input letter by letter with accuracy, which causes inconvenience. If the user does not know the exact URL address of the destination web page, access to the corresponding web page is not possible. Similarly, if the user does not know the e-mail address of the destination party, the mail cannot be sent.

Moreover, unlike a general personal computer (PC), a mobile terminal has a limited hardware resource. For this reason, Internet sites that the user can access by the related art method for transmitting a message are limited.

### SUMMARY OF THE INVENTION

One aspect of the present invention pertains to the recognition by the present inventors about the related art problems described above and about other limitations associated with the related art. Various features of the present invention have been developed, in part, based upon such recognition.

Therefore, an object of the present invention is to provide a mobile terminal, system and method for transmitting a message so as to be capable of setting priority for multiple reception types matching with (or associated with) a certain reception type and transmitting a message to a reception type that has the highest priority among the available reception types.

Another object of the present invention is to provide a mobile terminal, system and method for transmitting and/or receiving a message, which address the disadvantages and limitations associated with the related art.

Another object of the present invention is to provide a mobile communications terminal, system and method for transmitting a message so as to be capable of transmitting a message to at least two reception types selected by a user from multiple reception types matching with (associated with) a certain reception type.

Another object of the present invention is to provide a mobile terminal and communication system and method for transmitting and/or receiving a message using reception type data prestored at a control center.

According to an aspect of the present invention, there is provided a method for transmitting a message in a mobile communications system, the method comprising: a step in which a user inputs destination information for a message and writes the message; a step in which a mobile terminal checks transmission information of the message when the message transmission is set by the user; a step in which the mobile terminal transmits a message signal to a base station, the message signal including the message and either priority information or multiple-selection information according to the transmission information; and a step in which the base station transmits the message to at least one reception type associated with the destination information according to the priority information or multiple-selection information included in the message signal.

According to another aspect of the present invention, there is provided a mobile communications terminal comprising: a transmitting/receiving unit to perform a signal transmission; an input unit to receive a message and transmission information; a storage unit to store message data; and a controller to determine a message transmission mode of the message based on the transmission information, and to perform one of a general transmission process, a priority transmission process and a multiple-selection transmission process for the message based on the determined message transmission mode.

According to another aspect of the present invention, there is provided a method of receiving a message using a mobile terminal, comprising: registering a plurality of types of receiving information and/or priority information thereof; and receiving, by the mobile terminal, the message based on the plurality of types of receiving information and/or the priority information.

According to another aspect of the present invention, there is provided a system for receiving a message in a mobile communication, comprising: a server to register a plurality of types of receiving information and/or priority information thereof associated with each of a plurality of users; and a mobile terminal to receive the message based on the plurality of types of receiving information and/or the priority information registered in the server.

According to another aspect of the present invention, there is provided a mobile terminal comprising: an input unit to receive a message to be sent and one reception type of a recipient of the message from a user; and a controller to transmit the message and the received one reception type to a server, so as to send the message to the recipient through at least one reception type unknown to the user.

According to another aspect of the present invention, there is provided a server for transmitting a message to a communication terminal, the server comprising: a storage to register therein a plurality of reception type data for each of a plurality of subscribers associated with the server; and a controller to receive a message to be communicated from a first subscriber to a second subscriber, and destination information of the message from the first subscriber, and to examine the registered plurality of reception type data based on the destination information, so as to send the message to the second subscriber using at least one registered reception type data that is unavailable to the first subscriber.

20 The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a flow chart which illustrates a message transmission procedure in accordance with a related art;

FIG. 2 is a flow chart which illustrates a message transmission procedure in accordance with an embodiment of the present invention;

FIGS. 3A and 3B are views which illustrate examples of displays on a screen for setting message transmission in accordance with an embodiment of the present invention;

FIG. 4 is a view which illustrates an example of a database of a base station server for implementing the present invention according to an embodiment of the present invention; and

FIG. 5 is a view illustrating a construction of a mobile communications terminal for implementing the message transmission method in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

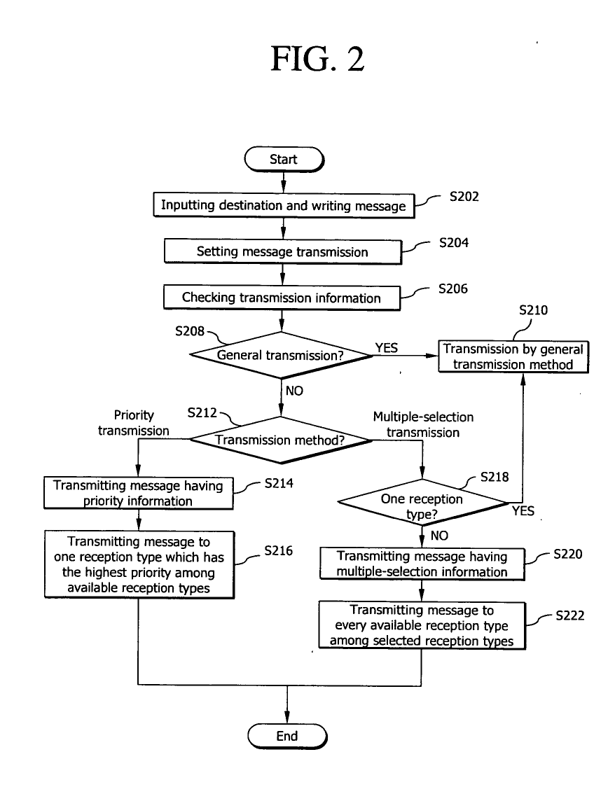

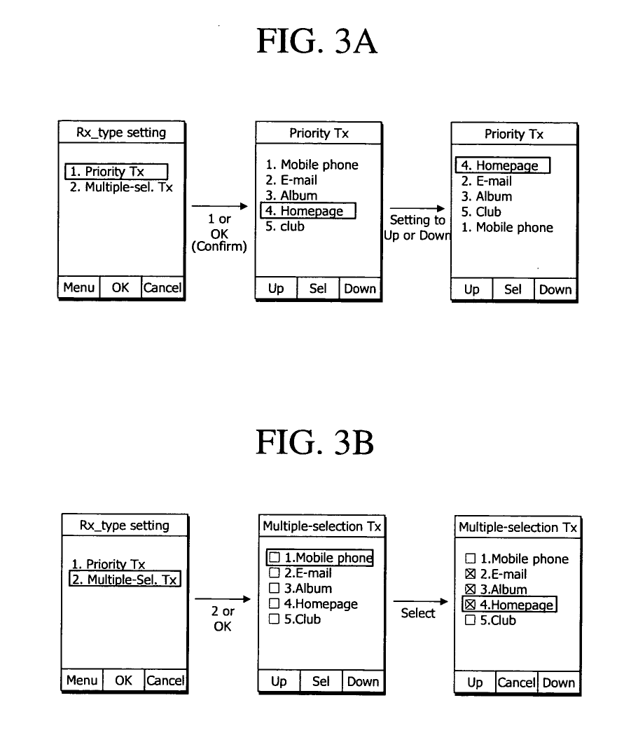

FIG. 2 is a flow chart which illustrates an implementing process of a method for transmitting a message in accordance with one embodiment of the present invention. This method can be implemented using a mobile terminal and/or other suitable device or system. For instance, the method can be implemented using the configurations and devices of FIGS. 3A-5.

Referring to FIG. 2, a user inputs destination information for a message to be transmitted and writes the message using a mobile terminal such as mobile phone, a PDA, etc. (S202). The destination information can be information identifying a destination of the message that the user intends to send, and can be in the form of a reception type. For instance, the destination information can include a name, phone number or e-mail address of a destination party who is to receive the message. Such destination information can be directly input by the user into the mobile terminal or can be prestored and selected when composing the message.

Then the user sets or selects a transmission mode of the message using the mobile terminal. In the alternative, the transmission mode of the message can be set, prior to writing the message at step SS02. The transmission mode can be set as one of the following modes including, but not limited to: a general transmission mode, a priority transmission mode, a multiple-selection transmission mode. The priority transmission mode allows a user to select one or more reception types (e.g., phone number, e-mail, home page, etc.) and set priority to these reception types, so that the user's written message can be sent to the destination party through the reception type that has the highest priority. The multiple-selection transmission mode allows a user to select a plurality of reception types preferred by the user, so that the user's written message can be sent to the destination party through each of the selected reception types of the destination party. These modes/types of transmission will be discussed later in more detail.

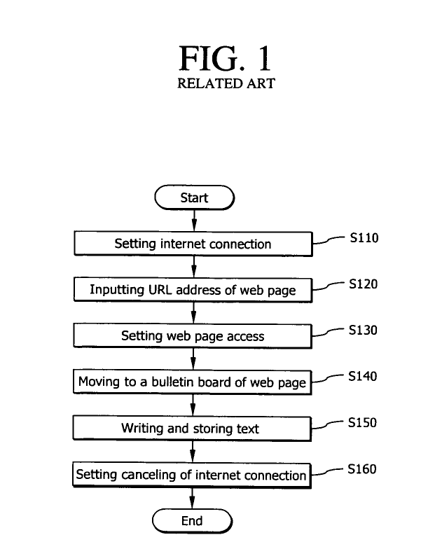

Once the transmission mode of the message is set by the user (S204), the mobile terminal checks message transmission information (S206) to determine whether the set transmission mode is a general transmission mode such as a one-to-one general transmission or a one-to-many general transmission (S208). If the message transmission information indicates that the set transmission mode of the written message is a general transmission mode, the message is transmitted according to the related art SMS message transmission method or the MMS message transmission method (S210). For instance, the message is processed and transmitted using the related art transmission method of FIG. 1.

If it is determined at step S208 that the transmission mode of the written message is not a general transmission mode, the mobile terminal determines whether the set transmission mode of the written message is a priority transmission mode or a multiple-selection transmission mode based on the message transmission information (S212).

If the determination result at step S212 shows that the user has set or selected a priority transmission mode, the mobile terminal transmits to a base station (or a server) a message signal including priority information that the user has designated (S214). The message signal includes the message written by the user to be sent to the destination party and the priority information which can be carried at a header part of the message or message signal. The communication between the mobile terminal and the base station may be made using known protocols and techniques.

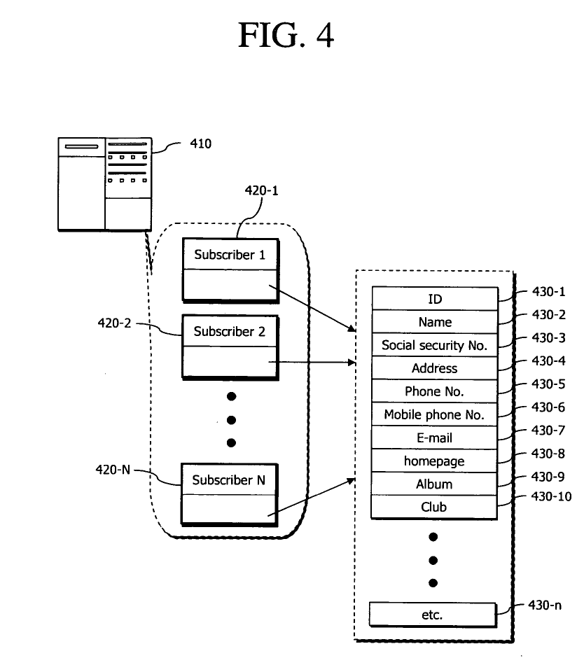

The base station prestores different reception types of each subscriber or customer in a database or other storage. For instance, as shown in FIG. 4, each subscriber registers with the base station a plurality of his/her reception types including, but not limited to, a name, a phone number, an e-mail address, etc. of the subscriber. Thus, the base station having received the message signal from the mobile terminal searches its database for any available reception types that match with (or associated with) the destination information input by the user, and transmits the message written by the user to one reception type having the highest priority among the available reception types that are found by the search (S216).

For instance, if the user has input a phone number (destination information) of the destination party but has set an e-mail (reception type) to have the highest priority in the priority transmission mode, then the base station searches its database and locates a subscriber that has the phone number matching the phone number (destination information) input by the user. Then the base station sends the user's message to the e-mail address of the located subscriber as registered in the database. Thus, in this example, the present invention allows the user to send a message to an e-mail address of a destination party without actually knowing the e-mail address, by using the destination party's phone number which the user knows. In other words, the present invention effectively allows a transmission of a message to a destination party through a desired reception type (not known to the user) of the destination party, using a reception type of the destination party that is known to the user.

If the determination result (S212) shows that the user sets the multiple-selection transmission mode, the mobile terminal determines whether the user selects only one reception type (S218). If the user has selected only one reception type, the message written by the user is transmitted to the selected reception type of the destination party by a general message transmission method/mode (S210). If the destination information matches the selected reception type of the destination party, then the message can be sent using a related art general message transmission method; if not, the database of the base station may be searched to locate the desired reception type. If the user selects at least two reception types, the mobile terminal transmits a message signal including multiple-selection information to the base station (S220). This message signal can include the multiple-selection information at its header part as an example, and includes the user's message to be sent to the destination party. If not, the user's message may be sent separately to the base station. The multiple-selection information includes one or more reception types preferred and selected by the user for the multiple-selection transmission mode.

At step S222, the base station having received the message signal searches its database and looks for any available reception types corresponding to the at least two reception types selected by the user and transmits the user's message to every available reception type located by the search. For instance, the base station searches its database for a reception type of a subscriber that matches the destination information (e.g., reception type) input by the user. Then the base station looks for all available reception types of the located subscriber that match the reception types selected by the user, and transmits the user's written message to each reception type that has been located.

According to an embodiment, at steps S216 and S222, the user can be informed of the status of the currently selected transmission mode, e.g., via a text message. For instance, in the priority transmission mode, although the user has selected an e-mail to have the highest priority, if the e-mail address of the destination party is not available so that the reception type having the next highest priority (e.g., phone number) is used to send the message, then the user may be informed of this at the user's terminal. In another example, if there are no available reception types among the reception types that match the reception types selected by the user in the multiple-selection transmission mode, then the user may be informed of this and the message may be sent using only the destination information input by the user.

According to the present invention, the reception type may be one of a phone number (e.g., mobile terminal number), an album web address, a homepage web address, an Internet club web address, and the like. Also, each user/subscriber can register with the base station a plurality of different reception types, and the registered reception types (e.g., phone numbers, web addresses, etc.) of the users/subscribers are different from each other. For instance, person A may register only his phone number, e-mail address and homepage address, whereas person B may register only his phone number, album web address, and Internet club web address. Accordingly, the base station needs to check the reception types and their availability (i.e., the availability of the reception type data such as whether or not an e-mail address has been registered for the reception type being the e-mail).

According to an embodiment of the present invention, the message written by the user may be an SMS message which is written as a simple text, or an MMS message including a picture, a moving picture, a sound, an animation, music, an emoticon, an icon, or the like attached thereto. The message signal can also be an SMS or MMS message signal.

The message transmission information is information for indicating a transmission mode set by the user, and can be expressed as ‘0’ for a general transmission mode, ‘1’ for a priority transmission mode, and ‘2’ for a multiple selection transmission mode. These are merely examples and other indications can be used.

According to an embodiment of the present invention, a general transmission mode can involve a one-to-one message transmission or a one-to-many message transmission in accordance with the related art. Here, according to the one-to-many message transmission, a sender's (user's) message is collectively transmitted to a plurality of receivers at the same time, only after the sender enters into the mobile terminal information on each of the receivers that are to receive the message. Accordingly, the one-to-many message transmission is different from the multiple-selection transmission of the present invention since in the one-to-many message transmission, the destination information of each of the plurality of receivers needs to be input by the user, which is not necessary in the present invention since the present invention utilizes subscribers' information pre-registered at the base station to obtain various destination information for different reception types.

The priority transmission mode and the multiple-selection transmission mode according to the present invention are now discussed in more detail.

In the priority transmission mode of the present invention, once the user sets priority for a plurality of reception types preferred by the user for sending the message or subsequent messages to provide priority information, the base station checks the prestored subscribers' information and locates a subscriber that has one of his/her prestored reception types that matches the destination information input by the user. Then the base station obtains a reception type among the subscriber's available reception types that has the highest priority set according to the priority information set by the user, and transmits the message to that reception type. Namely, the priority transmission is a method in which a message is transmitted to a reception type that the user does not know exactly by using a reception type that he knows exactly. According to an embodiment, the user at the user's mobile terminal can set priority for a list of reception types (for each message or as a default for all messages) as shown in FIG. 3A, even if the user does not know the exact reception type data (e.g., an exact URL address, e-main address, etc.) or the availability of those reception type data or reception types.

The priority for the reception types in the priority transmission mode may be previously set by the user through an environment of setting menus in the mobile terminal, or may be set by changing a preset value just before the message transmission. Also, the mobile terminal can have default priority values set as sequential values (priority level values) of reception types, which are synchronized with the base station, so that both the base station and the mobile terminal have the same priority information. The priority information can have order information including the sequential values that have been changed by the user on the basis of the default values. Also the base station can also set default multiple-selection information.

For instance, when the user sets the priority transmission after inputting or selecting one phone number of a destination party as the destination information of the user's message and writes the message. The user can set the priority of reception types using menus of the mobile terminal as shown in FIG. 3A. As an example, if the sequential values of the reception types, which are synchronized between the mobile terminal and the base station, are as follows as shown in FIG. 3A, the following sequential numbers are set as default priority values. Here, the top entry represents the highest priority, the bottom entry represents the lowest priority, and the priority decreases as the entry levels descend.
1. Phone (mobile terminal) number
2. E-mail address
3. Album web address
4. Homepage web address
5. Internet club web address

According to this example, the ‘phone number ’ reception type (“1. Mobile phone”) has the highest priority whereas the ‘Internet club web address’ reception type (“5. Club”) has the lowest priority, and the mobile terminal and the base station can be configured to store this priority information as default priority information.

Also, the user can change the priority for the plurality of reception types by using a direction key on the mobile terminal according to the user's preference as shown below and in FIG. 3A.
4. Homepage web address
2. E-mail address
3. Album web address
5. Internet club web address
1. Phone number In the above example, now the ‘homepage web’ reception type (“4. Homepage web address”) has the highest priority.

If the user changes the priority as mentioned above, the mobile terminal transmits to the base station, the message signal including transmission information (identifying a transmission mode of the message) and priority sequential values (priority information) designated by the user at the head part of the message. Only as an example, the priority information can be include number information such as ‘1/42351’. The base station having received the message signal recognizes that the desired transmission mode is the priority transmission mode since the first number of the information ‘1/42351’ is ‘1’. Also, from the following number ‘42351’, the base station can know the priority of the designated reception types from the highest priority reception type (4. homepage web address in the above example) to the lowest priority reception type (1. phone number). The base station that has checked every information determines whether these reception types are available, and transmits the message to one reception type that has the highest priority assigned among the available reception types. Here, the message transmitted to the reception type from the base station can exclude the priority information and/or transmission information.

In the multiple-selection transmission of the present invention, once the user selects at least two reception types among a list of reception types as shown in FIG. 3B, this multiple-selection information is transmitted to the base station. The base station searches its database to locate available reception types that match with (or associated with) the destination information (e.g., reception type data) input by the user, and transmits the user's message to every available reception type that has been located. Namely, since the message can be transmitted to at least two reception types among all the possible reception types of a destination party at the same time, the destination party can check the message transmitted by the user as soon as possible. The multiple-selection information has information of sequential values corresponding to reception types selected by the user among the sequential values. The multiple-selection information can be set by the user for all message (as default multiple-selection information) and/or set each time the user sends a message. The set multiple-selection information can also be modified as desired. Whenever new or changed multiple-selection information exists, this information is communicated to the base station from the mobile terminal. Also the base station can also set default multiple-selection information.

If the message signal transmitted from the mobile terminal includes the transmission information and multiple-selection information, e.g., ‘2/234’ as shown in FIG. 3B, the base station recognizes that the desired transmission is a multiple-selection transmission since the first number in “2/234” is ‘2’. Then, from ‘234’, the base station recognizes reception types (e.g., e-mail address, album web address and homepage web address in the example of FIG. 3B) to which the message is to be transmitted, determines whether the corresponding receiving types are available using the destination information input by the user and then, transmits the message to every available reception type that has been located according to the reception type data stored in the base station.

To implement the present invention described above, reception types of a subscriber should be stored in a database or other storage associated with a central controller such as a server at the base station or at the base station in which subscribers' information is stored. Since base station servers of most mobile communication service providers satisfy the aforementioned condition, description thereon will be simply made. FIG. 4 is a view which illustrates one example of a database of a base station server for implementing the present invention. Other examples and variations are possible.

Referring to FIG. 4, main fields (420-1˜420-N) (e.g., from at least tens of thousands to at most millions of main fields) exist in the database of the base station server 410 as a subscribers' information region. Each of the main fields (420-1˜420-N), which can be assigned to a subscriber includes detailed fields respectively storing an ID of a subscriber (430-1), a name of the subscriber (430-2), a social security number (430-3), an address (430-3), a wired terminal phone number (430-5), a mobile terminal phone number (430-6), an e-mail address (430-7), a homepage address (430-8), an album web address (430-9), an Internet club web address (430-10), and the like associated with the respective subscriber. Few relevant fields (e.g., 430-1˜430-7) of the detailed fields can be registered by the subscriber as requirement when the subscriber subscribes to the mobile communication service, and the rest or other (e.g., 430-8˜430-n) of the detailed fields are selectively registered by the subscriber as desired. Each subscriber can be informed of the possible use of information (reception type data) in the detailed fields, so the subscriber can decide if the reception type data should be entered for the detailed fields. And such database can be periodically or continuously updated to accurately reflect the current subscribers' current reception type data. The base station performs operations for implementing the present invention with reference to the main fields (420-1˜420-N) and the detailed fields (430-1˜430n).

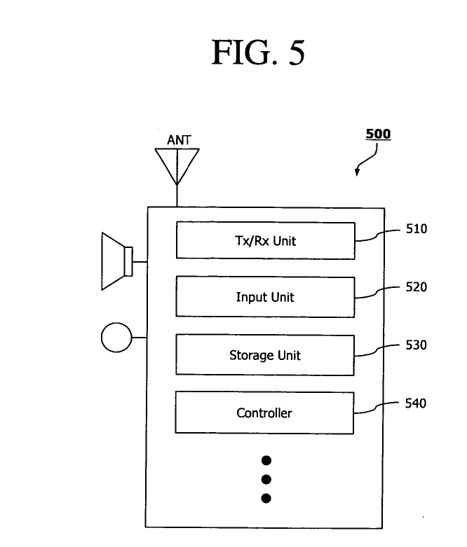

FIG. 5 is a view illustrating a construction of a mobile communications terminal for implementing a message transmission method in a mobile communications system in accordance with an embodiment of the present invention. As illustrated in FIG. 5, the mobile communications terminal 500 may include a transmitting/receiving unit 510 for signal transmission, an input unit 520 for inputting message and control commands, a storage unit 530 for storing data such as message data, transmission information, priority information, multiple-selection information, etc., and a controller 540 for controlling a determination of a message transmission mode and a performing one of a general transmission, a priority transmission and a multiple-selection transmission according to the determined message transmission mode according to the present invention. The mobile communications terminal 500 can include other components/functions known in the art, and is fully capable of communicating with the base station(s), networks such as the Internet, other communication terminal, other servers, other computers, etc.

When a message transmission is requested according to a message transmission setup by a user including a subscribed transmission, the controller 540 determines whether the requested message transmission mode is a general transmission such as the one-to-one transmission or the one-to-many transmission or a specific transmission including the priority transmission mode and the multiple-selection transmission mode base on the transmission information, and transmits the message according to a related art SMS message transmission method or MMS message transmission method when it is determined that the desired transmission is the general transmission.

However, when it is determined that the desired message transmission mode is a specific transmission mode other than the general transmission mode, the controller 540 determines whether the desired message transmission mode is a priority transmission mode or a multiple-selection transmission mode, e.g., based on the transmission information. When it is determined that the priority transmission is desired, the controller 540 transmits a message signal which includes the user's message and priority information assigned by the user in a header portion thereof to a base station via the transmitting/receiving unit 510, such that the base station can check available reception types among the multiple reception types, according to the priority set for the multiple reception types matching with (associated with) one reception type (destination information) set by the user or input thereby via the input unit 520, and transmit the message to one reception type having the highest priority among the available reception types.

When the desired message transmission mode is a multiple-selection transmission, the controller 540 includes multiple-selection information in the header portion of the message signal including the user's message, and transmits the message signal including the multiple-selection information to the base station via the transmitting/receiving unit 510, such that the base station can check all the available reception types among the reception types which are selected from the multiple reception types matching with (or associated with) one reception type (destination information) input by the user and transmit the message to each of the available reception types.

The input units 520 may include input means such as a keypad, a microphone, or touch screen, etc. and also include an input terminal for receiving signals by being connected with outer input means such as a keyboard.

The mobile communications terminal 500 may include output means such as a display panel, speaker, etc. and also include an output terminal for outputting signals by being connected with an external display device such as a television or monitor.

According to the present invention, the mobile terminal can be a mobile phone, a PDA, a smart phone, etc.

According to an embodiment, the present invention provides a method of receiving a message in a mobile terminal, which includes registering a plurality of types of receiving information (e.g., data for different reception types) and/or priority information thereof; and receiving the message based on the plurality of types of receiving information and/or the priority information. The receiving step may involve receiving the message through at least one reception type of higher priority than others among available reception types. Also, the plurality of types of receiving information (data for different reception types) may be at least one of a phone number, an e-mail address, a web address, and a home page address. The method may further comprise confirming available types of receiving information among the registered receiving information; and providing the message based on the available types of receiving information and/or the priority information.

According to an embodiment, the present invention also provides a system for receiving a message in a mobile communication environment, which includes a server for registering a plurality of types of receiving information (e.g., data for different reception types) and/or priority information thereof; and a mobile terminal for receiving the message from the server based on the plurality of types of receiving information and/or the priority information. Here, the mobile terminal may receive the message through at least one reception type of higher priority than others among available types of receiving information. The plurality of types of receiving information may be at least one of a phone number, an e-mail address, a web address, and a home page address. The server may be a base station or may be connected to the base station. Here, the server may further perform confirming available types of receiving information among the registered receiving information; and providing the message based on the available types of receiving information and/or the priority information.

According to an embodiment, the present invention also provides a method of transmitting a message in a mobile terminal, which includes receiving, for a receiver, a plurality of types of receiving information and/or a priority information thereof; and transmitting the message with the plurality of types of receiving information and/or the priority information. The transmitting step may involve transmitting the message to at least one reception type of higher priority than others among available types of receiving information. The plurality of types of receiving information may be at least one of a phone number, an e-mail address, a web address, and a home page address. The method may further comprise confirming available types of receiving information among registered receiving information; and providing the message with the available types of receiving information and/or the priority information.

In other words, the present invention encompasses a mobile terminal or other computer means (e.g., desktop, etc.), and a communication system and method for receiving a message using the registered subscribers' information on different reception types. Each subscriber can register different reception type data at the base station, and can register the subscriber's preferred priority order in which a message may be received by the subscriber. For instance, if a particular subscriber, as a recipient, desires to receive all messages through his e-mail first and then through his mobile phone, then this priority information of that subscriber can also be registered at the base station along with the reception type information such as the phone number, e-mail address, etc. of that subscriber as discussed above in connection with FIG. 4. Then a sender, using the present invention, generates and transmits his message to the base station, and the base station can send the message to the recipient according to the registered priority information of the recipient (and not of the sender). If there exist both the recipient's priority information and the sender's priority information, the service provider can configure its system to select and use one according to the service provider's preference or desired.

As described so far, in the method for transmitting and/or receiving a message in the mobile communications system in accordance with the present invention and the mobile communications terminal therefor, although not knowing every reception type of another party to receive a message, the user can transmit the message or upload an attached file to at least one desired reception type of various reception types (e.g., phone (mobile terminal) number, an e-mail address, an album web address, a homepage web address, an Internet club web address, or the like) which are previously stored in the base station, and match with (associated with) one reception type that the user knows exactly by the reception type, thereby improving the user's convenience.

Also, the method for transmitting and/or receiving a message in the mobile communications system in accordance with the present invention and the mobile communications terminal therefor enable the user to write a message using the mobile terminal and leaving it on an Internet homepage of another party or a bulletin board of a web site by an SMS or MMS message transmission metriod, thereby saving costs and wireless resources in comparison with the related art in which the user should access the Internet to leave a message on the board of the web side or the like.

According to the present invention, the user can send a message to a recipient through various receiving tools (reception types) such as e-mail, phone, website bulletin board, etc. of the recipient even if the user does not know all the address/destination information associated with all these receiving tools of the recipient. Also using the different transmission mode, the user can send his message to the recipient through the recipient's available receiving tool that is most preferred by the user or recipient based on the priority information in the priority transmission mode, or simultaneously through each of the recipient's available receiving tools that match the user's preferred receiving tools selected in the multiple-selection transmission mode. Because all the different receiving tool information (reception type data) is collected when the subscribers register with the base station, there is no need for each user (sender) to enter each and every reception type data associated with each recipient of the user's message. As a result, the present invention provides a convenient, efficient and effective way to transmit and receive messages among customers of a service using a mobile terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for transmitting a message in a mobile communications system, the method comprising:
a step in which a user inputs destination information for a message and writes the message;
a step in which a mobile terminal checks transmission information of the message when the message transmission is set by the user;
a step in which the mobile terminal transmits a message signal to a base station, the message signal including the message and either priority information or multiple-selection information according to the transmission information; and
a step in which the base station transmits the message to at least one reception type associated with the destination information according to the priority information or multiple-selection information included in the message signal.

2. The method of claim 1, further comprising:
a step in which the mobile terminal transmits the message by a general transmission method according to the transmission information of the message.

3. The method of claim 1, wherein the transmission information indicates a transmission mode set by the user for transmission of the message to a destination party.

4. The method of claim 3, wherein the transmission mode is one of the following: a general transmission mode, a priority transmission mode, and a multiple-selection transmission mode.

5. The method of claim 4, wherein if the transmission information is 0, the transmission mode is the general transmission mode; if the transmission information is 1, the transmission mode is the priority transmission mode; and if the transmission information is 2, the transmission mode is the multiple-selection transmission mode.

6. The method of claim 1, wherein if the transmission information indicates a priority transmission mode of the message, then the base station transmits the message to a reception type of a destination party that has the highest priority among all available reception types associated with the destination information according to the priority information.

7. The method of claim 1, wherein if the transmission information indicates a multiple-selection transmission mode of the message, then the base station transmits the message to each of at least one available reception type of a destination party associated with the destination information, which matches with a plurality of reception types selected by the user according to the multiple-selection information.

8. The method of claim 1, wherein the at least one reception type includes at least one of the following: a mobile phone number, an e-mail address, an album web address, a homepage web address, and an Internet club web address.

9. The method of claim 1, wherein the message comprises:
an SMS message written as a text; or
an MMS message having at least one of a picture, a moving picture, a sound, an animation, music, an emoticon and an icon attached thereto.

10. A mobile communications terminal comprising:
a transmitting/receiving unit to perform a signal transmission;
an input unit to receive a message and transmission information;
a storage unit to store message data; and
a controller to determine a message transmission mode of the message based on the transmission information, and to perform one of a general transmission process, a priority transmission process and a multiple-selection transmission process for the message based on the determined message transmission mode.

11. The terminal of claim 10, wherein if the transmission information is 0, the controller performs the general transmission process; if the transmission information is 1, the controller performs the priority transmission process; and if the transmission information is 2, the controller performs the multiple-selection transmission process.

12. The terminal of claim 10, wherein when the transmission information indicates a priority transmission mode of the message, the mobile terminal transmits priority information associated with the message to a server, the priority information indicating a transmission priority level for each of at least one reception type set by a user.

13. The terminal of claim 12, wherein the at least one reception type includes at least one of the following: a mobile phone number, an e-mail address, an album web address, a homepage web address, and an Internet club web address.

14. The terminal of claim 10, wherein when the transmission information indicates a multiple-selection transmission mode of the message, the mobile terminal transmits multiple-selection information to a server, the multiple-selection information identifying at least two reception types selected by a user for transmission of the message.

15. The terminal of claim 14, wherein the at least two reception types include at least two of the following: a mobile phone number, an e-mail address, an album web address, a homepage web address, and an Internet club web address.

16. The terminal of claim 10, wherein the message includes:
an SMS message written as a text; or
an MMS message having at least one of a picture, a moving picture, a sound, an animation, music, an emoticon and an icon attached thereto.

17. A method of receiving a message using a mobile terminal, comprising:
registering a plurality of types of receiving information and/or priority information thereof; and
receiving, by the mobile terminal, the message based on the plurality of types of receiving information and/or the priority information.

18. The method of claim 17, wherein the receiving step comprises:
receiving the message through a reception type that has the highest priority among available reception types based on the plurality of types of receiving information and priority information.

19. The method of claim 17, wherein the plurality of types of receiving information include at least one of a phone number, an e-mail address, a web address, and a home page address.

20. The method of claim 17, further comprising:
determining availability of the registered plurality of types of receiving information; and
receiving, by the mobile terminal, the message based on the determined availability and/or the priority information.

21. A system for receiving a message in a mobile communication, comprising:
a server to register a plurality of types of receiving information and/or priority information thereof associated with each of a plurality of users; and
a mobile terminal to receive the message based on the plurality of types of receiving information and/or the priority information registered in the server.

22. The system of claim 21, wherein the mobile terminal receives the message through a reception type that has the highest priority among available reception types based on the plurality of types of receiving information and priority information.

23. The system of claim 21, wherein the plurality of types of receiving information include at least one of a phone number, an e-mail address, a web address, and a home page address.

24. The system of claim 21, wherein the server is a base station or is connected to the base station.

25. The system of claim 21, wherein the server determines availability of the registered plurality of types of receiving information, and transmits the message to the mobile terminal based on the determined availability and/or the priority information.

26. A mobile terminal comprising:
an input unit to receive a message to be sent and one reception type of a recipient of the message from a user; and
a controller to transmit the message and the received one reception type to a server, so as to send the message to the recipient through at least one reception type unknown to the user.

27. The mobile terminal of claim 26, wherein the controller also transmits transmission information associated with the message to the server, the transmission information identifying a transmission mode of the message.

28. The mobile terminal of claim 27, wherein the transmission mode is one of the following: a general transmission mode, a priority transmission mode, and a multiple-selection transmission mode.

29. The mobile terminal of claim 27, wherein when the transmission information indicates a priority transmission mode of the message, the mobile terminal transmits priority information associated with the message to the server, the priority information indicating a transmission priority level for each of at least one reception type set by the user.

30. The mobile terminal of claim 27, wherein when the transmission information indicates a multiple-selection transmission mode of the message, the mobile terminal transmits multiple-selection information to the server, the multiple-selection information identifying at least two reception types selected by the user for transmission of the message.

31. The mobile terminal of claim 26, wherein the at least one reception type unknown to the user includes at least one of the following: a mobile phone number, an e-mail address, an album web address, a homepage web address, and an Internet club web address.

32. The mobile terminal of claim 26, wherein the message includes:
an SMS message written as a text; or
an MMS message having at least one of a picture, a moving picture, a sound, an animation, music, an emoticon and an icon attached thereto.

33. A server for transmitting a message to a communication terminal, the server comprising:
a storage to register therein a plurality of reception type data for each of a plurality of subscribers associated with the server; and
a controller to receive a message to be communicated from a first subscriber to a second subscriber, and destination information of the message from the first subscriber, and to examine the registered plurality of reception type data based on the destination information, so as to send the message to the second subscriber using at least one registered reception type data that is unavailable to the first subscriber.

34. The server of claim 33, wherein the controller also receives transmission information of the message, the transmission information indicating a transmission mode set by the first subscriber for transmission of the message to the second subscriber.

35. The server of claim 34, wherein the transmission mode is one of the following: a general transmission mode, a priority transmission mode, and a multiple-selection transmission mode.

36. The server of claim 33, wherein if the transmission information indicates a priority transmission mode of the message, then the controller transmits the message to the second subscriber using a reception type that has the highest priority among reception types of all registered reception type data associated with the destination information according to priority information.

37. The server of claim 36, wherein the priority information is set by the first subscriber.

38. The server of claim 36, wherein the priority information is set by the second subscriber.

39. The server of claim 33, wherein if the transmission information indicates a multiple-selection transmission mode of the message, then the controller transmits the message using each of at least one registered reception type data of the second subscriber, which is associated with the destination information and matches with at least one of a plurality of reception types selected by the user according to multiple-selection information.

40. The server of claim 33, wherein the message includes:
an SMS message written as a text; or
an MMS message having at least one of a picture, a moving picture, a sound, an animation, music, an emoticon and an icon attached thereto.

41. The server of claim 33, wherein the plurality of reception type data registered in the storage include at least one of the following: a mobile phone number, an e-mail address, an album web address, a homepage web address, and an Internet club web address associated with each subscriber.
